(19) United States
(12) Patent Application Publication
(10) Pub. No.: US 2016/0042348 A1
(43) Pub. Date: Feb. 11, 2016

(54) INFORMATION PROCESSING DEVICE AND INFORMATION PROCESSING SYSTEM

(71) Applicant: PANASONIC INTELLECTUAL PROPERTY MANAGEMENT CO., LTD., Osaka (JP)

(72) Inventors: Takeshi NINOMIYA, Osaka (JP); Seiro SHIMODA, Fukuoka (JP)

(73) Assignee: PANASONIC INTELLECTUAL PROPERTY MANAGEMENT CO., LTD., Osaka (JP)

(21) Appl. No.: 14/816,414

(22) Filed: Aug. 3, 2015

(30) Foreign Application Priority Data
Aug. 7, 2014 (JP) 2014-161861

(51) Int. Cl. G06Q 20/40; G06Q 20/38

(52) U.S. Cl. CPC G06Q 20/40; G06Q 20/382

(57) ABSTRACT

In a settlement system, a credit card determination unit collates an input card number with negative data of an acquirer or a settlement processor which is accumulated in a negative data table of an acquirer or a settlement processor and store's internal negative data accumulated in a store's internal negative data table, and determines whether or not the settlement process is executable by using the input card number based on the collation result. In a case where a negative data updating unit updates the store's internal negative data by itself, a communication unit distributes the updated store's internal negative data to other settlement terminal devices. In addition, the communication unit receives the updated store's internal negative data from the other settlement terminal devices.

### BACKGROUND OF THE INVENTION

1. Field of the Invention

The present invention relates to an information processing device and an information processing system which executes a settlement process by using identification information of the customer's card.

2. Description of the Related Art

In the related art, as an example of the information processing device, a settlement terminal device is widely used in stores and determines whether a credit card is valid or invalid when executing the settlement process. In this determination, the settlement terminal device determines whether the settlement process of the credit card is valid or invalid by referring to negative data which is card information used to determine the settlement process to be invalid. The negative data is data including, for example, an invalid card number which cannot be subject to the settlement process. The settlement terminal device executes the settlement process when a determination result is valid, but does not execute the settlement process when a determination result is invalid.

In addition, the determination of whether the credit card is valid or invalid may be executed by a settlement server device installed in an information management center in some cases. In this case, the settlement server device accumulates the negative data in advance which is created on the basis of cases of failure in the past settlement process. The settlement terminal device communicates with the settlement server device when determining whether a credit card is valid or invalid, and then receives the determination result.

On the other hand, there are some cases where the settlement server device may transmit the negative data to the settlement terminal device in advance, and the settlement terminal device may store the transmitted negative data. In this case, the settlement terminal device executes the determination of whether the credit card is valid or invalid as an off line process without communicating with the settlement server device.

In this way, in a case where the settlement terminal device executes a determining process itself (its own device), for example, the settlement terminal device disclosed in Japanese Patent Unexamined Publication No. 2008-197955 manages the negative data by storing a list of the card number which is included in the negative data as a table.

However, in the above described settlement terminal device, if update frequency of the negative data which is transmitted from the settlement server device is low, there is a possibility that a credit card which is suspected to be invalid may be used before data of the credit card is reflected in the negative data. In a case where the credit card which is invalid is used, the affiliated store will be damaged. In addition, if the frequency of use of the card is high or the use money amount is increased, the damage becomes greater, and in accordance with an agreement between the affiliated store and the acquirer (that is, a company which collects affiliated stores dealing with the transaction of a designated credit card, and integrates a sales amount of the credit card) which manages affiliated stores, or between the affiliated store and a settlement processor (that is, a company which is entrusted from the acquirer with the service for performing a settlement agency), the damage to the acquirer or the settlement processor also becomes greater.

### SUMMARY OF THE INVENTION

When executing a settlement process by using a customer's card, an information processing device of the present disclosure can suppress an inappropriate settlement process by using invalid information obtained from its own device in addition to invalid information acquired from other devices as invalid information which does not allow the settlement process to be executed.

The information processing device of the present disclosure is an information processing device which executes the settlement process by using identification information of the customer's card. The information processing device includes an accumulation unit that accumulates first invalid information which causes the information processing device to determine that the settlement process is invalid based on determination results obtained from other information processing devices and second invalid information which causes the information processing device to determine that the settlement process is invalid based on the determination result obtained from its own device; an input unit that receives input of the identification information; and a determination unit that collates the input identification information with the first invalid information and the second invalid information which are accumulated in the accumulation unit and then, based on the collation result, determines whether or not the settlement process executed by using the input identification information which is acceptable.

An information processing system of the present disclosure is an information processing system in which a plurality of information processing devices, which execute a settlement process by using identification information of a customer's card, are communicably connected to each other. The information processing device includes an accumulation unit that accumulates first invalid information which causes the information processing device to determine that the settlement process is invalid based on determination results obtained from at least one of the plurality of information processing devices except for its own device and second invalid information which causes the information processing device to determine that the settlement process is invalid based on the determination result obtained from the own device; an input unit that receives input of the identification information; and a determination unit that collates the input identification information with the first invalid information and the second invalid information which are accumulated in the accumulation unit and then, based on the collation result, determines whether or not the settlement process executed by using the input identification information is acceptable.

According to the present disclosure, when executing a settlement process by using a customer's card, the information processing device can suppress an inappropriate settlement process by using invalid information obtained from a store's internal device in addition to invalid information acquired from other devices as invalid information which does not allow the settlement process to be executed.

### BRIEF DESCRIPTION OF THE DRAWINGS

FIG. 1A is a diagram illustrating the entire configuration of a settlement system including a settlement terminal device of an exemplary embodiment;

FIG. 1B is a front view illustrating the appearance of a settlement terminal device;

FIG. 2 is a diagram illustrating a configuration of the settlement terminal device which is connected to a local area network together with other settlement terminal devices;

FIG. 3 is a table illustrating registration details of a negative data table of an acquirer or settlement processor and a negative data table of stores' own device, which are stored in a flash ROM;

FIG. 4A is a flowchart illustrating an operation procedure of updating store's internal negative data in the settlement system of the exemplary embodiment by an alarm and event generated from a store's internal device;

FIG. 4B is a flowchart illustrating an operation procedure of updating the store's internal negative data in the settlement system of the exemplary embodiment to the store's internal negative data which is distributed from other settlement terminal devices; and

FIG. 5 is a flowchart illustrating a procedure of the settlement process in the settlement system of the exemplary embodiment.

### DETAILED DESCRIPTION OF THE PREFERRED EMBODIMENTS

Hereinafter, exemplary embodiments of the present disclosure will be described with reference to the accompanying drawings. In the exemplary embodiment, as an information processing device according to the present invention, a settlement terminal device is used to execute a settlement process in transactions of goods or services is exemplified.

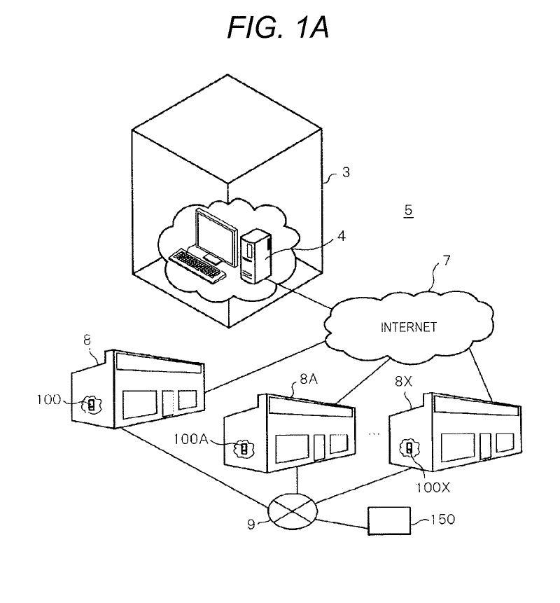

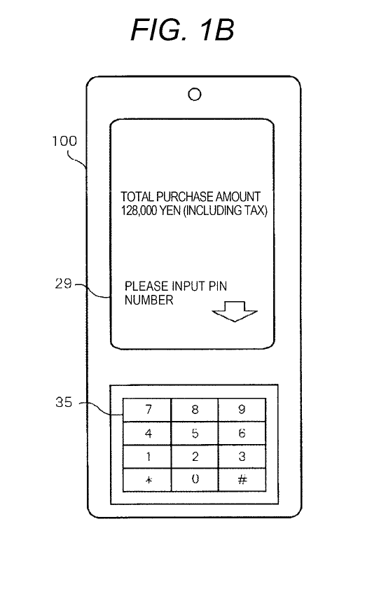

FIG. 1A is a diagram illustrating the entire configuration of settlement system 5 including settlement terminal device 100 of an exemplary embodiment. Settlement system 5 illustrated in FIG. 1A has a configuration in which data processing device (a settlement server device) 4 which is used to execute the settlement process in the transactions of goods or the like and is installed in settlement center 3, and each of settlement terminal devices 100, 100A, . . . , and 100X which is installed in each affiliated store (a store) 8 and are connected to each other via Internet 7.

The affiliated store is assumed to be a chain store in this exemplary embodiment, and since there are a plurality of affiliated stores 8, 8A, . . . , and 8X which are designed in almost the same manner, unless otherwise specified, the plurality of affiliated stores 8, 8A, . . . , and 8X are represented by affiliated store 8. In addition, as the settlement terminal device which is installed in each of the affiliated stores, since there are a plurality of settlement terminal devices 100, 100A, . . . , and 100X of which specifications are the same, and unless otherwise specified, the plurality of settlement terminal devices are represented by the settlement terminal device 100. Meanwhile, the same is true for a case in which the plurality of settlement terminal devices are respectively installed in each sales floor when assuming that the affiliated store is not the chain store but a large scale store.

In the exemplary embodiment, settlement terminal devices 100, 100A. and 100X which are respectively installed in each of the affiliated stores 8, 8A, . . . , and 8X are connected to each other via local area network (LAN) 9. In addition, terminal management device 150 which manages settlement terminal devices 100, 100A, . . . , and 100X is connected to local area network 9. This terminal management device 150 is installed in an arbitrary place. Local area network 9 may be a wireless LAN.

In the present embodiment, settlement terminal devices 100, 100A, . . . , 100X are connected to each other via local area network 9 without using Internet 7 (public communication network), but may be connected to each other by constructing a virtual private network (VPN) in Internet 7. Alternatively, settlement terminal devices 100, 100A, . . . , and 100X may be connected to Internet 7, a public switched telephone network (PSTN), or a radio telephone network (a mobile phone line such as wideband code division multiple access (W-CDMA), code division multiple access (CDMA), long term evolution (LTE), and a universal mobile telecommunication system (UMTS)). Settlement terminal devices 100, 100A, . . . , and 100X may be connected to each other via, for example, a multiple-network which is constructed by combining several networks described above.

In the exemplary embodiment, as a typical transaction of goods or the like, the number of a credit card which belongs to a person (a customer) performing the transaction is collated with the card number which is registered as negative data. Here, the negative data is invalid card information (invalid information) which cannot be subject to the transaction when the transaction (for example, a settlement process) is performed, in other words, card information (the invalid information) which causes the information processing device to determine that the transaction is invalid. For example, the credit card number which is suspected of unauthorized use in a past transaction. Meanwhile, the negative data may include information of a card issuing company or an expiration date in addition to the card number. In the exemplary embodiment, while settlement terminal device 100 executes the collation of the number of the customer's credit card with the card number registered in the negative data, settlement server device 4 also may execute the same operation.

In a case of a credit card which is not registered in the negative data, settlement terminal device 100 or settlement server device 4 verify whether or not a person performing the transaction is the same person who has the credit card which is used in the transaction. At this time, the person performing the transaction (an operator) inputs a personal identification number (PIN) to settlement terminal device 100.

Settlement server device 4 of settlement center 3 receives PIN information which is input to settlement terminal device 100 via Internet 7, and collates the received PIN information with authentication information which is registered in a database in advance. As a result of the collation, if the authentication is successful, settlement center 3 executes a credit check on this operator.

Settlement terminal device 100 continues the settlement process when the credit check is authorized by settlement center 3 in a case where the used credit card is not registered in the negative data as the collation result obtained by settlement terminal device 100.

FIG. 1B is a front view illustrating the appearance of a settlement terminal device 100. Settlement terminal device 100 is a portable device capable of being held by the operator, and includes display unit 29 and key input unit 35 on an operation surface. Meanwhile, display unit 29 and key input unit 35 may be configured to have a touch panel which is integrated with a display unit and an input detection unit. In addition, settlement terminal device 100 may be a stationary device.

A message urging the input of the information of settlement amounts and PIN is displayed on a screen of display unit 29. Key input unit 35 as an example of an input unit includes a PIN pad which allows a touch input and receives, for example, the input of the card number of the customer (for example, the credit card).

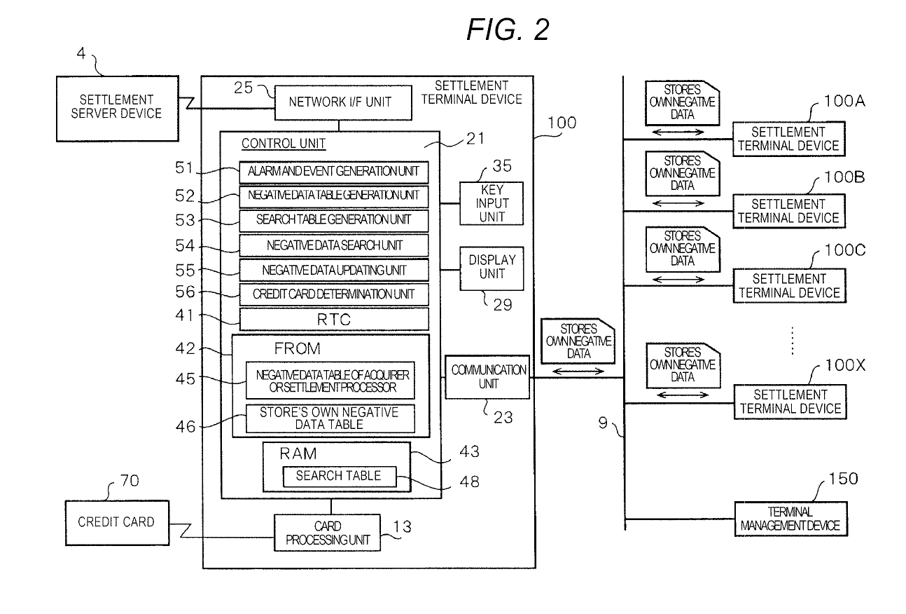

FIG. 2 is a diagram illustrating a configuration of the settlement terminal device 100 which is connected to a local area network (LAN) 9 together with other settlement terminal devices 100A, 100B, 100C, . . . , and 100X. Settlement terminal device 100 includes control unit 21 as a main component.

Control unit 21 is connected to network I/F unit 25 which is connected to settlement server device 4 and controls communication with Internet 7, key input unit 35 which includes a PIN pad, display unit 29 which displays various kinds of information on the screen, and communication unit 23 which controls communication with local area network 9 in the chain stores. Through a broadcast distribution method, communication unit 23 distributes negative data to other settlement terminal devices 100A, 100B, 100C, . . . , and 100X which are communicably connected to each other in the chain stores. Meanwhile, communication unit 23 can also distribute negative data through a unicast distribution method. Control unit 21 is connected to card processing unit 13 which reads out information regarding credit card 70 which is any one of a magnetic card, a contact type IC card, and a non-contact type IC card.

Control unit 21 includes hardware resources such as real time clock (RTC) 41, flash ROM 42, and RAM 43. In addition, control unit 21 includes alarm and event generation unit 51, negative data table generation unit 52, search table generation unit 53, negative data search unit 54, negative data updating unit 55, and credit card determination unit 56, and performs the settlement process.

Flash ROM 42, as an example of an accumulation unit, stores negative data table of acquirer or settlement processor 45 registering a list of negative data (hereinafter, referred to as “negative data from acquirer or settlement processor”) as an example of first invalid information received (obtained) or distributed from settlement center 3, acquirer (a company which manages affiliated stores), issuer (the card issuing company), a settlement processor, or the like, and store's internal negative data table 46 registering a list of negative data (hereinafter, referred to as “store's internal negative data”) as an example of second invalid information which is generated in the chain stores (affiliated stores 8, 8A, . . . , and 8X). The negative data of the acquirer or the settlement processor is data including the negative data allowing the information processing device to determine that the reception of a settlement process is invalid based on the determination result obtained from other information processing devices in a case where an inappropriate settlement process or the like occurred in other information processing devices (settlement center 3, the acquirer, the issua, and the settlement processor are also included) in the past. In addition, store's internal negative data is data including negative data allowing the information processing device to determine that the reception of settlement process is invalid based on the determination result obtained from each information processing device in a case where an inappropriate settlement process or the like occurred in each information processing device in the past. In the exemplary embodiment, these items of negative data are simply referred to as, unless otherwise specified, negative data. A negative data table of acquirer or settlement processor 45 and store's internal negative data table 46 may be respectively stored in a different storage medium.

RAM 43 stores search table 48 associating an address of negative data (save location information) which is registered in negative data table of acquirer or settlement processor 45 and store's internal negative data table 46, with the card number (card identification information). RTC 41 is a timepiece IC displaying the present time.

Negative data table generation unit 52 generates store's internal negative data table 46 and stores store's internal negative data table 46 in flash ROM 42.

Alarm and event generation unit 51 generates, for example, an alarm and event warning that there is a new credit card which is suspicious in a case where a salesperson has a doubt about the authenticity of the credit card number based on his or her subjective judgment and thus operates a particular key which is key input unit 35. Alternatively, alarm and event generation unit 51 generates the alarm and event warning that there is a new credit card which is suspicious in a case when the salesperson, who has a suspicion that the credit card is likely to be used by a person who is not authenticated as the owner of the credit card, operates a particular key which is key input unit 35. If this alarm and event is generated, the store's internal negative data which is registered in store's internal negative data table 46 is updated. Then, the card number of credit card 70 becomes invalid. In addition, at this time, alarm information is displayed on display unit 29. Further, in a case where a speaker is built in settlement terminal device 100, the alarm information may be generated from the speaker as a sound.

As an example of an update unit, negative data updating unit 55 updates the store's internal negative data which is registered in store's internal negative data table 46 by using the card number in which the alarm and event is generated by alarm and event generation unit 51. In addition, negative data updating unit 55 updates negative data table of acquirer or settlement processor 45 when the negative data of the acquirer or settlement processor is received from settlement center 3 and the like.

Search table generation unit 53 generates search table 48 which associates the address of the negative data with the card number as described above, and then stores search table 48 in RAM 43.

Negative data search unit 54 searches in search table 48 by using the card number input from card processing unit 13, and investigates whether or not there is corresponding negative data.

As an example of a determination unit, credit card determination unit 56 determines the validity of credit card 70, if credit card 70 is valid, the settlement process is allowed to be executed, and if credit card 70 is invalid, the settlement process is stopped.

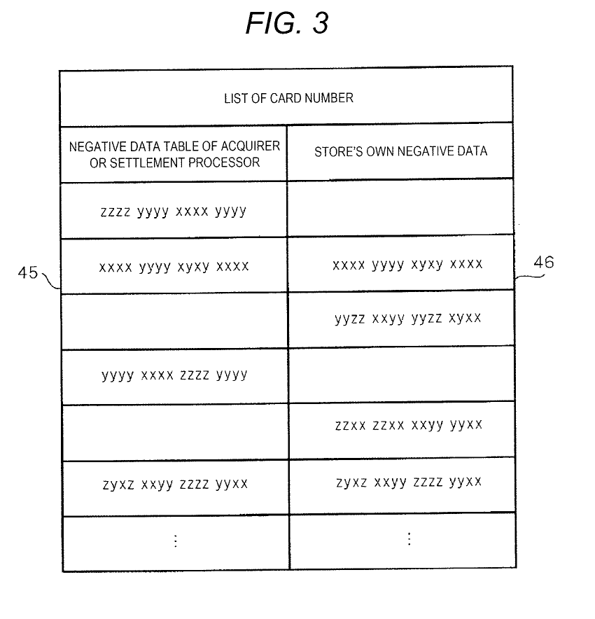

FIG. 3 is a table illustrating registration details of negative data table of acquirer or settlement processor 45 and store's internal negative data table 46 which are stored in flash ROM 42. The negative data of the acquirer or settlement processor registered in negative data table of acquirer or settlement processor 45 and the store's internal negative data registered in store's internal negative data table 46 may be partially overlapped in some cases or may be not overlapped at all. Generally, since the negative data of the acquirer covers a wide area which covers a plurality of affiliated stores and the update is less frequently performed, a time lag occurs, for example, and it takes about two or three months to register an inappropriate transaction as the invalid card information in the affiliated store from the time when the inappropriate transaction occurs. On the other hand, the store's internal negative data covers a narrow area and the update is highly frequently performed, and thus, for example, when the salesperson generates the alarm information during customer services, the invalid card information is immediately registered. Generally, the number of items of the negative data of the acquirer or settlement processor is greater than the number of items of the store's internal negative data. Any one number of the numbers 0 to 9 is applied to each of x, y, and z illustrated in FIG. 3.

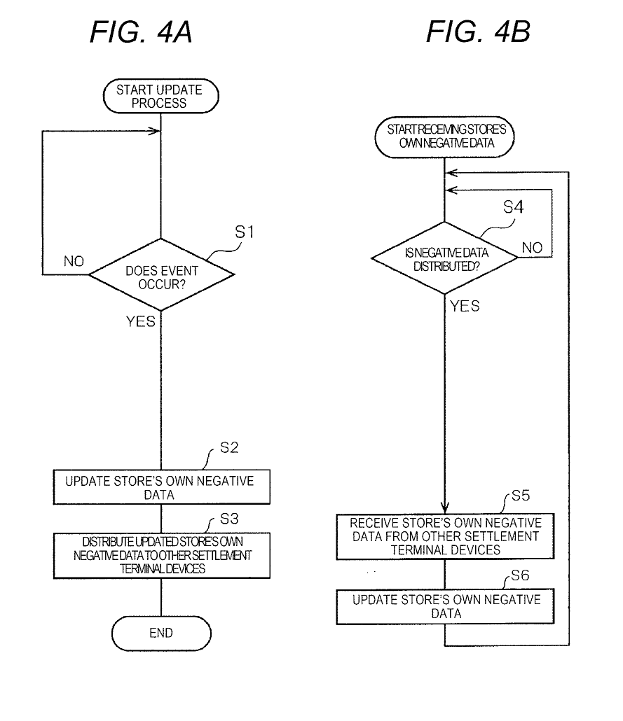

Next, an operation procedure of updating the store's internal negative data of settlement terminal device 100 of the exemplary embodiment will be described with reference to FIGS. 4A and 4B. FIG. 4A is a flowchart illustrating the operation procedure of updating the store's internal negative data in the settlement terminal device 100 of the exemplary embodiment with an alarm and event generated by store's internal device. FIG. 4B is a flowchart illustrating the operation procedure of updating the store's internal negative data in the settlement terminal device 100 of the exemplary embodiment to the store's internal negative data which is distributed from other settlement terminal devices. The settlement terminal device 100 of the exemplary embodiment causes the process by the flowchart illustrated in FIG. 4A and the process in the flowchart illustrated in FIG. 4B to be executed in parallel.

In FIG. 4A, negative data updating unit 55 determines whether or not the alarm and event is generated by alarm and event generation unit 51 (S1). In a case where the alarm and event is not generated by alarm and event generation unit 51 (S1, NO), negative data updating unit 55 repeatedly determines the process in step S1.

In a case where the alarm and event is generated (YES in S1), negative data updating unit 55 adds the card number of credit card 70 which is read out from card processing unit 13 as the store's internal negative data, and updates the registration details of store's internal negative data table 46 (S2).

Communication unit 23 distributes store's internal negative data which is updated in step S2 to all of other settlement terminal devices 100A, 100B, . . . , and 100X (S3). Accordingly, the process of the flowchart illustrated in FIG. 4A ends.

On the other hand, in FIG. 4B, communication unit 23 determines whether or not the negative data is distributed from other settlement terminal devices (S4). In a case where the store's internal negative data is distributed from other settlement terminal devices (YES in S4), communication unit 23 receives the store's internal negative data from other settlement terminal devices (S5).

Negative data updating unit 55 updates the registration details of store's internal negative data table 46 by using the received store's internal negative data (S6). Thereafter, negative data updating unit 55 returns to determine whether or not the negative data is distributed, as illustrated in step S5.

As described above, settlement terminal device 100 acquires the store's internal negative data via an acquisition route which is different from negative data of the acquirer or settlement processor, and distributes all of other settlement terminal devices 100A, 100B, . . . , and 100X and the store's internal negative data.

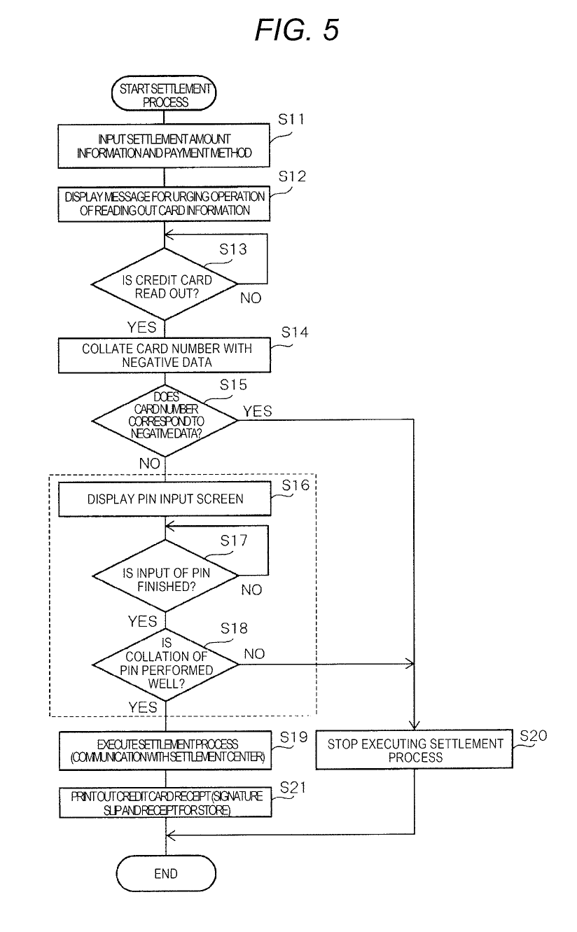

Subsequently, a procedure of the settlement process of settlement terminal device 100 of the exemplary embodiment will be described with reference to FIG. 5. FIG. 5 is a flowchart illustrating the procedure of the settlement process of settlement terminal device 100 of the exemplary embodiment.

In FIG. 5, settlement terminal device 100 starts the settlement process by executing a settlement application which is installed in flash ROM 42. First, when receiving the input of the settlement amount information and a payment method (S11), control unit 21 causes display unit 29 to display a message for urging the operation of reading out the card information (S12).

Card processing unit 13 waits until credit card 70 is read out (S13). When credit card 70 is read out, negative data search unit 54 inputs the read out card number of the credit card 70, and searches search table 48 by using the input card number.

Credit card determination unit 56 collates the input card number with the negative data of the acquirer or settlement processor which is registered in negative data table of acquirer or settlement processor 45 and the store's internal negative data which is registered in store's internal negative data table 46 (S14). Credit card determination unit 56 determines whether or not the input card number corresponds to the negative data based on the collation result (S15).

In the settlement executed by using an IC credit card, in a case where the input card number does not correspond to the negative data, control unit 21 causes display unit 29 to display a PIN pad (S16). Control unit 21 waits until the PIN information which is input from key input unit 35 is received, and then when the PIN information is received (S17), determines whether or not the input PIN information coincides with the PIN information which is registered in the credit card read out in step S13 (S18). If the items of PIN information coincide with each other, control unit 21 continues the next settlement process (S19). Then, control unit 21 prints out a credit card receipt (S21).

On the other hand, if the items of PIN information do not coincide with each other, control unit 21 stops executing the settlement process (S20). Thereafter, control unit 21 ends the process in the flowchart illustrated in FIG. 5.

In the settlement executed by using a magnetic credit card or the settlement executed by using a digital money card, in a case where the input card number does not correspond to the negative data, control unit 21 skips the execution in each process in steps S16 to S18 after executing the process in step S15, and executes the settlement process in step S19. That is, the process of control unit 21 is omitted in steps, after step S15 to before S19. Thereafter, control unit 21 prints out the credit card receipt (S21). In the settlement executed by the magnetic credit card in step S21, control unit 21 prints out a signature slip and a receipt for the store which require the signature of a user of the credit card in addition to the credit card receipt. Thereafter, control unit 21 ends the process of the flowchart illustrated in FIG. 5.

Similar to the case of the settlement executed by using the IC credit card as described above, control unit 21 may execute the settlement process in step S19 after executing the processes in steps S16 to S18 without skipping any even in the case of the settlement executed by using the magnetic credit card or the case of the settlement executed by using the digital money card.

On the other hand, as the collation result in step S15, if the input card number corresponds to the negative data, control unit 21 moves to the process in step S20 and immediately stops executing the settlement process. Thereafter, control unit 21 ends the process in the flowchart illustrated in FIG. 5.

As described above, in settlement system 5 of the exemplary embodiment, credit card determination unit 56 collates the input card number with the negative data of the acquirer or settlement processor which is accumulated in negative data table of acquirer or settlement processor 45 and the store's internal negative data which is accumulated in store's internal negative data table 46, and then, based on this collation result, determines whether or not the settlement process is executable by using the input card number.

From the above description, in settlement system 5, settlement terminal device 100 determines whether or not the settlement process is executable by using not only the negative data of the acquirer or settlement processor which is acquired from other settlement terminal devices but also the store's internal negative data as the invalid information which does not allow the settlement process to be executed in the settlement process executed by using the customer's card, and thus it is possible to efficiently suppress the inappropriate settlement process. Accordingly, since the store's internal negative data or the negative data of the acquirer or settlement processor (for example, the negative data of the credit card which is suspicious of being invalid) is rapidly reflected in the information processing device in the store, settlement terminal device 100 can suppress the settlement process executed after the credit card, which is suspected of inappropriate transaction use in the past settlement process, from being used, thereby preventing the spread of damage due to inappropriate use of the credit card in the affiliated stores, the stores, and the chain stores.

Settlement terminal device 100 can reduce the damage to the acquirer if there is a responsibility to compensate for the damage to the acquirer in accordance with the terms and conditions between the affiliated store and the acquirer.

Settlement terminal device 100 distributes the updated store's internal negative data to other settlement terminal devices 100A, . . . , and 100X in a case where an event of the alarm information (predetermined information) is detected in the internal device and the store's internal negative data is updated. In addition, in a case where a predetermined event is detected in other settlement terminal devices 100A, . . . , and 100X and the store's internal negative data is updated, settlement terminal device 100 receives the updated store's internal negative data from other settlement terminal devices 100A, . . . , and 100X.

In addition, settlement terminal device 100 does not cause the store's internal negative data to be stored on a single server device but can cause the store's internal negative data to be dispersed to the plurality of settlement terminal devices. Accordingly. settlement terminal device 100 can eliminate the need for preparing a complex and expensive server, and can be used to construct settlement system 5 which suppresses an increase in cost and has excellent failure resistance. In addition, the update information of the store's internal negative data is quickly reflected in settlement terminal device 100 in the store in comparison with the negative data of acquirer or settlement processor. Therefore, settlement terminal device 100 suppress the settlement process executed after processing the credit card, which is suspected of the inappropriate transaction use in the past settlement process, from being used, thereby preventing the spread of damage due to the inappropriate use of the credit card in the affiliated stores, the stores, and the chain stores.

Since settlement terminal device 100 updates the store's internal negative data which is registered in the store's internal negative data table by using the store's internal negative data received from other settlement terminal devices 100A, . . . , and 100X at each predetermined period even when the events are not detected, for example, even in a case where, due to temporary failure, the store's internal negative data is not able to be received from other settlement terminal devices, it is possible to update the store's internal negative data after a predetermined period of time elapses. Therefore, it is possible to set the store's internal negative data to the latest date.

While various embodiments have been described with reference to the accompanying drawings, it is needless to say that the invention is not limited thereto. It is clear that those skilled in the art can conceive of various changes and modifications within the scope described in the claims, and it is understood that various changes and modifications are also within the technical scope of the present invention.

For example, in the above described embodiments, a settlement terminal device is installed in each of the plurality of stores (chain stores), and the plurality of settlement terminal devices and the terminal management device are connected to each other via the local area network. However, the plurality of settlement terminal devices may be installed in each sales floor of a large scale store, and may be connected to each other in the same way as that in the above description.

In addition, in the present embodiment, in a case where the salesperson in each store has doubt about the authenticity of the credit card based on his or her subjective judgment, the salesperson operates a particular key of the key input unit to generate the event. However, the event may be automatically generated by determination of an image analysis device (not shown) instead of the determination of the salesperson. For example, the image analysis device generates the event based on behavior of a person who holds a credit card, which is captured by a surveillance camera. Alternatively, the event may be automatically generated based on local information each store owns about the person who holds the card.

What is claimed is:

1. An information processing device which executes a settlement process by using identification information related to a customer's card, comprising:
an accumulation unit that accumulates first invalid information which causes the information processing device to determine that the settlement process is invalid based on determination results obtained from other information processing devices and second invalid information which causes the information processing device to determine that the settlement process is invalid based on the determination result obtained from its own device;
an input unit that receives input of the identification information; and
a determination unit that collates the input identification information with the first invalid information and the second invalid information which are accumulated in the accumulation unit and then, based on the collation result, determines whether or not the settlement process executed by using the input identification information is executable.

2. The information processing device of claim 1, further comprising:
an update unit that updates the second invalid information accumulated in the accumulation unit; and
a communication unit that communicates with the other information processing devices and distributes the second invalid information to the other information processing devices;
wherein in accordance with a predetermined event detected in the own device, the communication unit distributes the updated second invalid information to the other information processing devices when the second invalid information is updated by the update unit, and
wherein in accordance with a predetermined event detected in the other information processing devices, the updated second invalid information is received from the other information processing devices when the second invalid information is updated.

3. The information processing device of claim 2,
wherein the update unit updates the second invalid information accumulated in the accumulation unit by using the second invalid information which is received from the other information processing devices during each predetermined period.

4. An information processing system in which a plurality of information processing devices, which execute a settlement process by using identification information of a customer's card, are communicably connected to each other,
wherein the information processing device includes
an accumulation unit that accumulates first invalid information which causes the information processing device to determine that the settlement process is invalid based on determination results obtained from at least one of the plurality of information processing devices except for its own device and second invalid information which causes the information processing device to determine that the settlement process is invalid based on the determination result obtained from its own device;
an input unit that receives input of the identification information; and
a determination unit that collates the input identification information with the first invalid information and the second invalid information which are accumulated in the accumulation unit and then, based on the collation result, determines whether or not the settlement process executed by using the input identification information is acceptable.
